(19) United States
(12) Patent Application Publication
(10) Pub. No.: US 2002/0156848 A1
(43) Pub. Date: Oct. 24, 2002

(54) Method and system for conducting a convention online

(76) Inventor: Lawrence Grouse, Gig Harbor, WA (US)

Correspondence Address: HANDAL & MOROFSKY, 80 WASHINGTON STREET, NORWALK, CT, 06854, US

(21) Appl. No.: 09/918,302

(22) Filed: Jul. 30, 2001

Related U.S. Application Data
(63) Continuation-in-part of application No. 09/841,696, filed on Apr. 24, 2001.

(51) Int. Cl. G06F 15/16

(52) U.S. Cl. 709/204

(57) ABSTRACT

In accordance with the invention, a method for establishing an electronic convention comprising providing a central server programmed with convention software adapted to register participants to a convention over a publicly accessible or privately accessible computer network, make available over the publicly accessible or privately accessible computer network information of interest to the participants to the convention, and receive information from the participants over the publicly accessible or privately accessible computer network. A plurality of screens are provided to participants from the central server, at least one of the screens including a hyperlink which may be clicked on to transfer traffic to a second server other than the central server, the second server performing at least one convention function.

### TECHNICAL FIELD

The present invention generally relates to a system and method for conducting an online convention by establishing network connections for conferencing over computer networks, and more particularly, a method for establishing conferences and linking online participants to the conferences during a convention over the internet.

### REFERENCE TO GOVERNMENT FUNDING

Not Applicable.

### BACKGROUND OF THE INVENTION

It has long been recognized that the exchange of ideas between people is an important tool in promoting progress. Given the global nature of many enterprises, the importance of people meeting people with common interests or pursuits in other parts of the world is particularly acute today. Nor is this a new phenomenon. Indeed, even in the Middle Ages, when bankers met once a year to exchange notes and settle accounts, an important function of these meetings was the exchange of information and ideas, and the implementation of new procedures. Indeed, the importance of such exchanges of information was implicitly recognized under old Anglo-Saxon town hall customs, which required the drinking of mead by participants to insure a level of intoxication which would result in the removal of inhibitions and the implementation of a frank and full exchange of ideas.

Today, national conventions perform these functions. However, conventions are an extremely expensive way to exchange information, requiring expenditures for airfare, hotels, restaurants, liquor (even after the turn of two millennia) food, and the like, while at the same time inconveniencing the organizations participating in the convention on account of the absence of key personnel from the home office.

As difficult as the organization and implementation of a convention on a nationwide basis is, the problems are dwarfed in comparison to the issues presented by international conventions, which typically involve participants from such far-flung locations as Japan, the United States, Western Europe, Russia, South America and India. In this case, not only are the participants traveling great distances, but when they get to the location, they are on significantly different body clocks and have difficulty participating efficiently in the proceedings. In addition, language problems impede communication make getting along in the host country difficult for persons not fluent in the language.

As a consequence, the burden of such a convention is such that, in many cases, conventions are not held even every year, when, for example, the holding of conventions several times a year would be useful. For example, patent attorney's meet at their world convention once every three years. Notwithstanding, almost every month important changes in the law are being proposed, evaluated and implemented in different countries, and oftentimes, these actions are being taken in one country without knowledge of good and bad experiences which have occurred in other countries.

The traditional model of an on-line information exchange system consists of a host server connecting a number of persons to an event, such as a concert through their respective individual channels. This is a client/server relationship where a host server connects a number of clients. Under this model, a great deal of computing resources are consumed by the host server. This model would also be limiting for conducting an interactive conference with multiple speakers and a large number of participants.

### SUMMARY OF THE INVENTION

It is therefore an object of the present invention to provide a method for dynamically establishing a conference and conducting a convention over the internet.

The old model is no longer adequate in meeting the dynamic and flexible environment demanded by the activity of the network users of today and of the future. In accordance with the invention, given the level of activity on the internet, a different model, using, at least in part, a peer-to-peer relationship between users is implemented. Therefore, there is no absolute host server, and a number of participants or speakers may be connected via a number of channels in a variety of manners. The advantage with this model is that there is not a central host server to connect the clients. As long as the participants or speakers utilize application programs allowing communication across the networks, this model is feasible and desirable for establishing a conference and conducting a convention.

In hosting a conference, in accordance with the invention, over a computer network such as the internet, the conference host advertises and promotes the conference as to the subject matter of the conference and the time and location of the conference. Parties interested in participating in the conference join the conference via their network connections at the designated time.

The preferred embodiment of the present invention provides a virtual conference hall/convention center on the World-Wide Web (“WWW”). A user, by using a web-browser and a helper-application program, may go to the virtual conference hall, announce and advertise a conference, create a conference, or join an on-going conference.

The host machine supporting the virtual conference hall does not actually host any conferences by receiving and redistributing data packets. Rather, the virtual conference hall facilitates the establishment of conference connections for users wishing to participate in a conference. Once a conference is established, data transmission from one user to another user is routed directly via the appropriate internet protocol and transmission paths. For example, a user, by indicating the conference of his or her choice, is connected to the conference whereby an internet connection is automatically established between this user and one of the existing conference participants without the user having to know the IP address of a conference participant.

These and other objects and advantage of the present invention will no doubt become obvious to those of ordinary skill in the art after having read the following detailed description of the preferred embodiments.

Other objects and advantages of the invention will be evident from the following detailed description when read in conjunction with the accompanying drawings which depicts an illustrative embodiment of the invention.

In accordance with the invention, these and other objects are implemented through the use of a computer-based information exchange system. While the provision of information is, to a large extent provided by a central server, in accordance with the invention, different “rooms” in the inventive website are, in fact, operated by different persons utilizing different servers. This is achieved by placing hyperlinks on a main page of the electronic convention, which hyperlinks are linked to, for example, a server hosting the website of a person wishing to provide an exhibit at the convention. The page of the website of the exhibitor, in turn, has hyperlinks which return the visitor back to the convention at the point in the website of the convention where the user was hyperlinked to the exhibitor's “exhibition hall”.

In addition, in accordance with the invention, problems involving different “body clock” times for different participants are eliminated by having each local unit participating in the virtual convention operating at a time which is physiologically nonburdensome and convenient for the different participants, while, at the same time, providing this information at later times to persons attending the convention who are located in remote locations in significantly different time zones. While persons attending talks can do so in real-time and thus question the speaker in real-time, and the speaker's answers can be provided in real-time to persons attending the talk and real-time, persons attending the talk at a different time can email questions for answer by the person getting the seminar or assistant to the person, and selected or all questions and answers can be added to the transcript of the talk.

Furthermore, also in accordance with the invention, it is contemplated that translation software will convert the proceedings, in real-time, into various languages, including the translation of questions to the language of the speaker for answer.

In connection with such questions for the speaker and the text of a particular speech, it is also contemplated in accordance with the invention that the same can be made available in audio form both in real-time and at other times. Furthermore it is also contemplated that a person sending in questions, may be given the option of talking their questions into the computer and having the same e-mailed as an audio file, and that if such a question is selected, the audio file will also be played back to persons accessing the particular talk.

In accordance with the invention, a method for establishing an electronic convention comprising providing a central server programmed with convention software adapted to register participants to a convention over a publicly accessible or privately accessible computer network, make available over the publicly accessible or privately accessible computer network information of interest to the participants to the convention, and receive information from the participants over the publicly accessible or privately accessible computer network. A plurality of screens are provided to participants from the central server, at least one of the screens including a hyperlink which may be clicked on to transfer traffic to a second server other than the central server, the second server performing at least one convention function.

The second server provides a plurality of pages, at least half of the pages on the second server having a respective button which may be clicked on to return a convention registrant to the central server. Another screen provides the option to convention registrants of a convention email account with a known limited period of existence, the screen informing the registrant respecting the time limited nature of the convention e-mail account.

A central server is programmed with convention software adapted (i) to register participants to a convention over a publicly accessible or privately accessible computer network, (ii) make available over the publicly accessible or privately accessible computer network information of interest to the participants to the convention, wherein the information is made available in the form of a plurality of website pages; and (iii) receive information from the participants over the publicly accessible or privately accessible computer network.

A page receiving identification and money transfer information is made available to potential registrants to the electronic convention; All website pages are made available to persons which register into the electronic convention. Persons who do not register into the electronic convention are given access to only a limited number of website pages.

Conversely, in response to the detection of the clicking by a potential registrant on any function meant to present a website page other than one of the limited number of website pages, such potential registrants are presented with a page receiving identification and money transfer information.

On the other hand, a potential registrant who has been given the option in response to the detection of the clicking on a function meant to present a website page other than one of the limited number of website pages, the page receiving identification and money transfer information, is given the further option of deciding not to register and returning to the limited access browsing allowed by the system without registration.

In accordance with a preferred embodiment of the invention, a screen is provided to convention participants to provide the functions of a presentation by a speaker, the screen including (i) a picture of the speaker, (ii) a window with a scrolling feature incorporating the text of the speech of the speaker, (iii) an invitation to submit a question to the speaker, (iv) a field for receiving the question, and (v) a button for sending the question to set speaker to be included with any response within the window with a scrolling feature.

In accordance with the preferred embodiment, participants are also provided, from the central server, with a screen serving as a bulletin board and including general messages to participants located in areas organized according to topic.

### BRIEF DESCRIPTION OF THE DRAWINGS

Further objects, features, and advantages of the present invention will become apparent upon consideration of the detailed description of the presently-preferred embodiments, when taken in conjunction with the accompanying drawings. It is noted, however, that the appended drawings illustrate only a typical embodiment of this invention and is therefore not to be considered limiting of its scope, for the invention may admit to other equally effective embodiments. Reference the appended drawings, wherein:

FIG. 1 is a flow chart illustrating features of the inventive online convention;

FIG. 2 is a homepage of an embodiment in accordance with the present invention;

FIG. 3 is a convention foyer web page;

FIG. 4 is a press room web page;

FIG. 5 is an exhibit hall registration web page;

FIG. 6 is an exhibit hall sponsor list web page;

FIG. 7 is a linking central web page;

FIG. 8 is documents room web page;

FIG. 9 is a first registration screen including a field for indicating the category of a potential convention registrant;

FIG. 10 is a window advising of the need to register;

FIG. 11 is a window representing a first at the position registration;

FIG. 12 is a window representing a second step in position registration;

FIG. 13 is a window offering downloading software;

FIG. 14 is a window advising registrants of their personal identification numbers;

FIGS. 15 through 17 are windows representing first registration screens for persons other than a physician;

FIGS. 18 through 20 are windows representing second registration screens for persons other than physicians;

FIG. 21 is a screen for setting up an e-mail account;

FIG. 22 is a selection screen allowing navigation through a convention;

FIG. 23 illustrates the internal arrangement of selection screens for multiple types of visitors;

FIG. 24 is a window comprising the homepage of a sponsor of the convention;

FIG. 25 is a website page presenting a presentation being given by a speaker;

FIG. 26 is a website page during the presentation of FIG. 25, wherein a question is being answered;

FIG. 27 is a website screen for presenting a seminar;

FIG. 28 is a website screen for presenting a press conference; and

FIG. 29 is a system diagram of a system for implementing the method of the present invention.

### DETAILED DESCRIPTION OF THE INVENTION

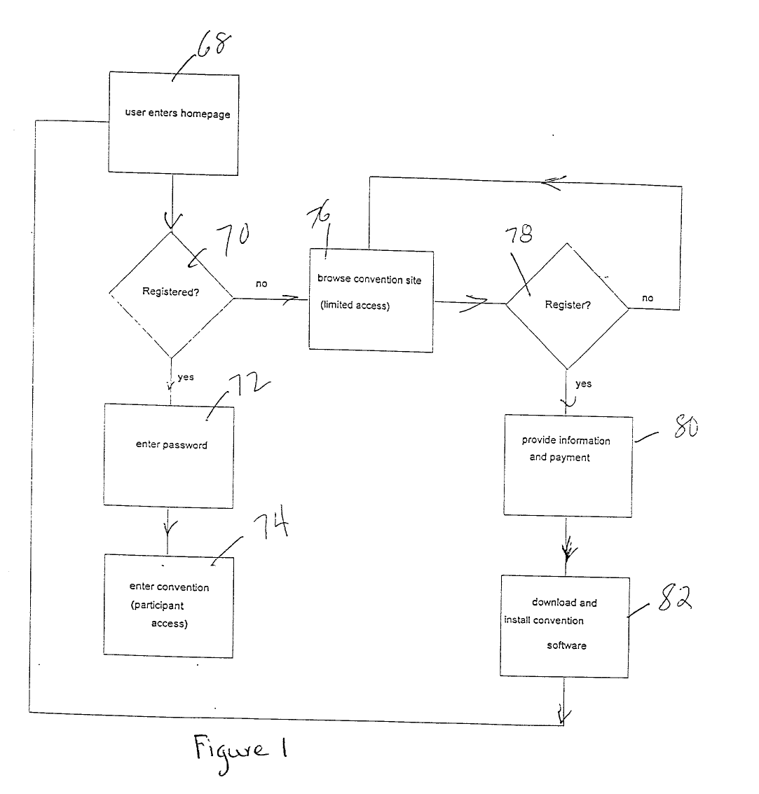

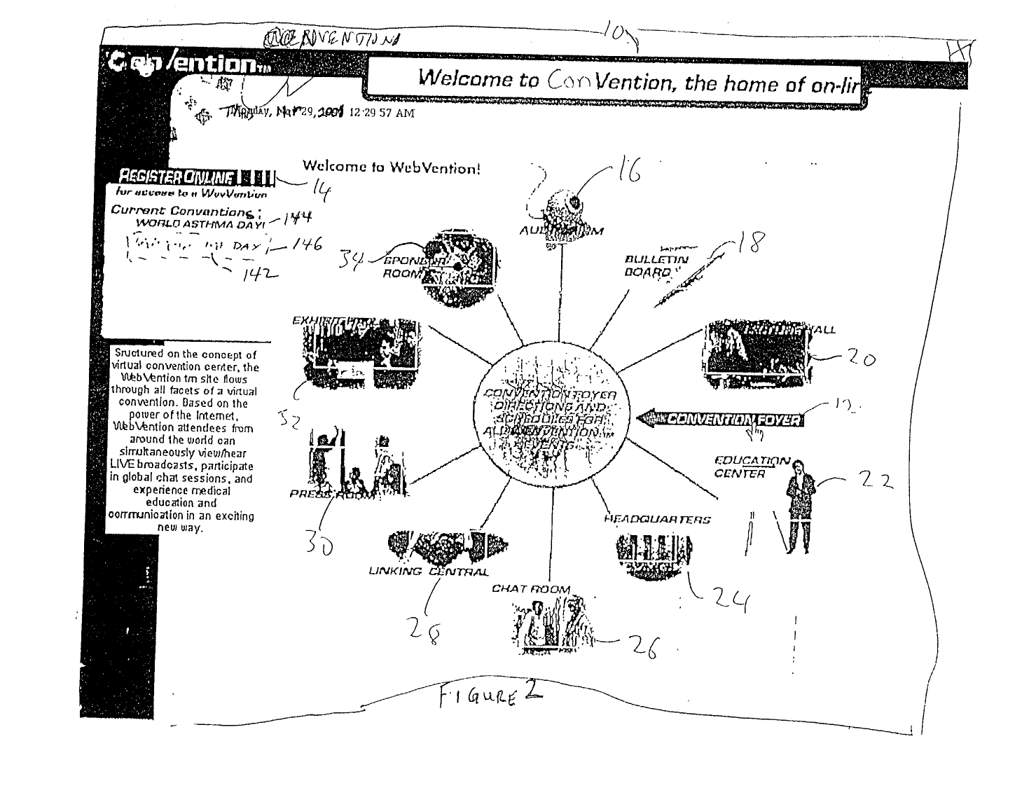

FIG. 1 is a flow diagram illustrating the method of the present invention. A user arrives via Internet hyperlink, search engine, by entering a particular web address in a Web browser, etc. to a homepage of the inventive system, such as homepage 10 illustrated in FIG. 2. Each user arriving at the inventive convention site enters via the homepage. If the user is not registered as a participant, the user may browse the convention to obtain information regarding the convention features, such as exhibitions, conferences, educational materials, etc., prior to registering. The extent of information obtainable by unregistered users may be limited by a convention manager. The user may register during any time while browsing the convention site.

If the user is registered or completes the registration process, they may enter a security code or password to gain access to the system. There may also be general or specific limitations to certain areas depending on the participant and type of registration completed. For example, being registered as a participant would not provide access to administrative and managerial features of the inventive convention. However, the user may enter and participate in chat rooms, read press releases, or learn about the sponsors and exhibits.

The registration process requires submitting personal and professional information, if applicable, and typically requires payment of a fee. Once the items have been entered and accepted by the inventive system, software including codes or password setting information for security deactivation and clearance, would be provided to the participant. This permits the participant to access convention features. The software is downloadable by the participant but may be provided through other media forms as well. Once the software is on the participant's hard drive, the participant may run its executable files to install the convention software. The convention software may have features that include chat-enabling software, help scheduling exhibitions and events, or providing reminders and guiding the participant through the convention web site. The software also permits the user to establish a participant identity or screen name and a personal password.

The user is allowed full access as a participant in the inventive convention after being registered and entering his or her screen name and password where prompted to do so, thus signing on. The inventive online convention comprises exhibits, resources and information that would be available to participants at any “physical” convention. However, because the inventive convention is online, many more participants can join, attend and benefit from its features, that may not have otherwise for a variety of reasons, including geography, timing, cost, etc. Certain activities, such as conferences and lectures and the like, may be broadcasted live or replayed via the web to all registered users signed on at the scheduled time. All participants interested in the activity would sign on and navigate the convention web site until finding the link to the appropriate portion of the web site where the activity is set to occur.

FIGS. 2-8 depict an embodiment of the inventive convention web site and screen pages. The illustrated embodiment presents the inventive convention in the context of providing a convention entitled “Global Initiative for Obstructive Lung Disease” hereinafter referred to as GOLD. Of course, many types of conventions having other themes may be conducted in accordance with the present invention.

A home page 10, having a plurality of links to various events in accordance with the present invention's objective of establishing an online convention and conference center. Home page 10, which can be accessed by using a web browser to go to a designated site on the internet such as “www.webvention.org.”, serves as an online lobby, providing information, directions and schedules for accessing convention events, attractions and offerings in the convention foyer 12. Once a user is registered via an online registration system 14, or if the user is registered already, the user may access all features in the online convention. Certain features may be accessible only to those registered users. As shown, home page 10 contains links to auditorium 16, bulletin board 18, lecture hall 20, education center 22, headquarters 24, chat room 26, linking central 28, press room 30, exhibit hall 32 and sponsor room 34. There are computer-generated or other graphics employed throughout the pages in this embodiment to make the page itself attractive and provide a visual clue as to the information obtainable via the various links. In addition, a trademark 36 symbol for the convention is illustrated on the pages.

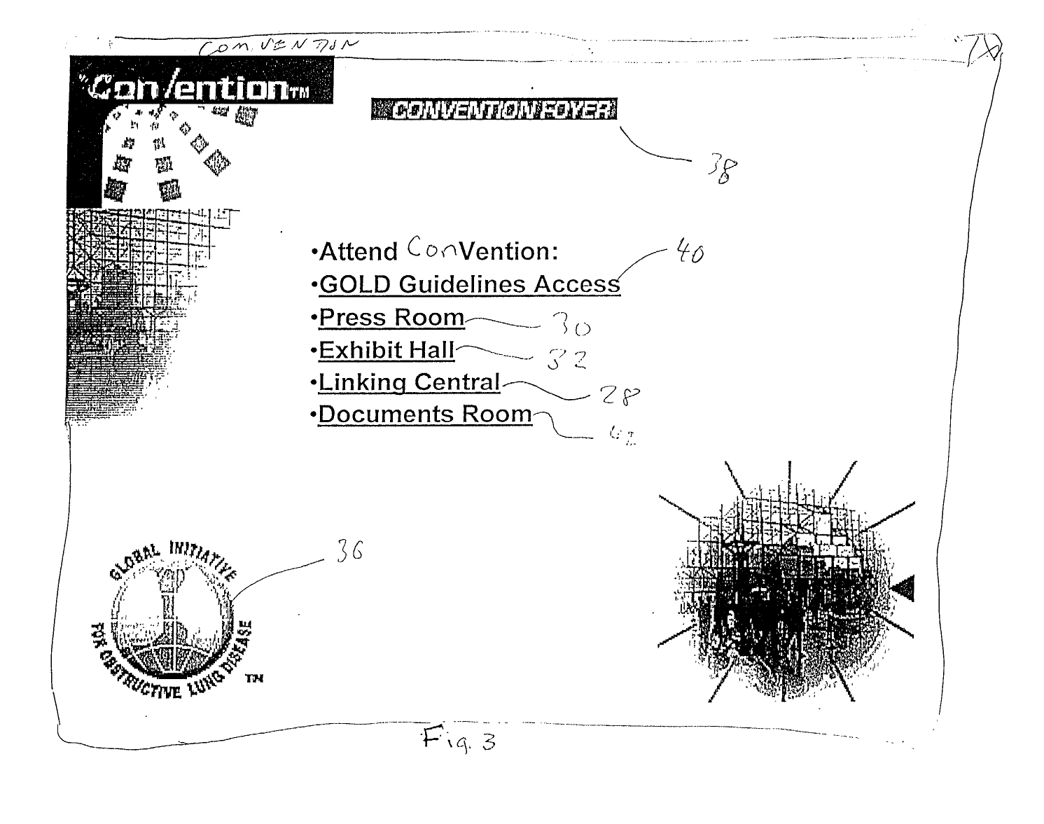

A convention foyer page 38 is illustrated in FIG. 3, providing links to guideline access 40, press room 30, exhibit hall 32, linking central 28 and documents room 42. Guidelines access 40 provides a table of contents, executive summary, and searching and downloading capability of the guidelines for the convention.

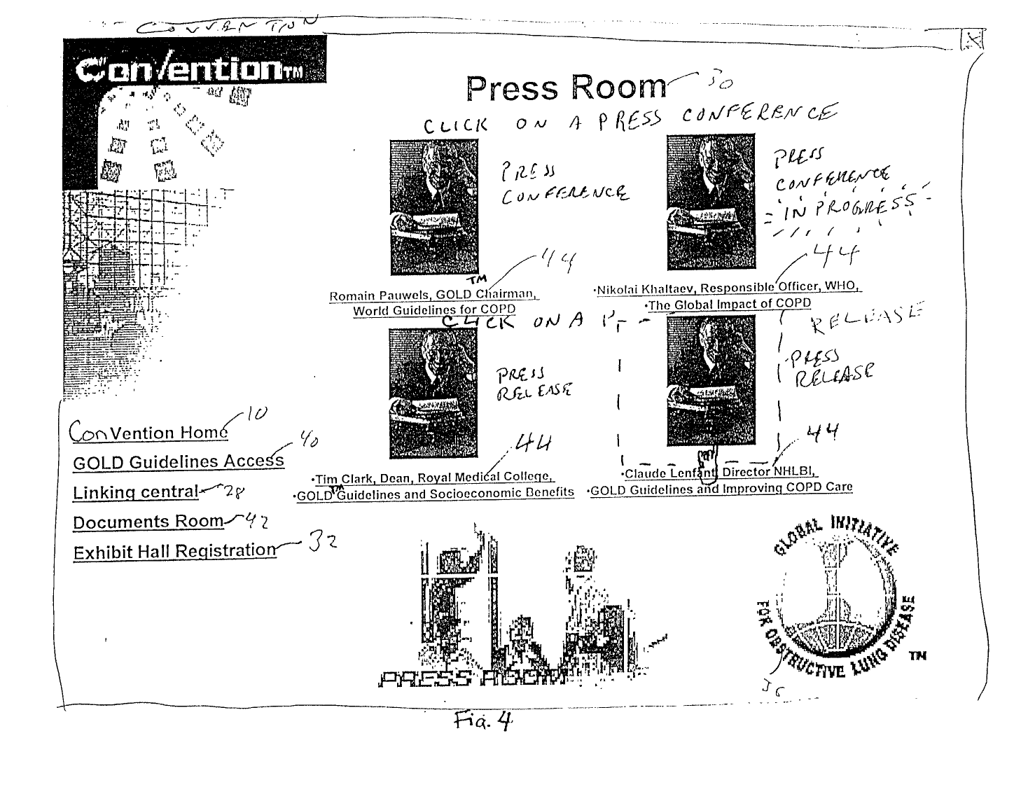

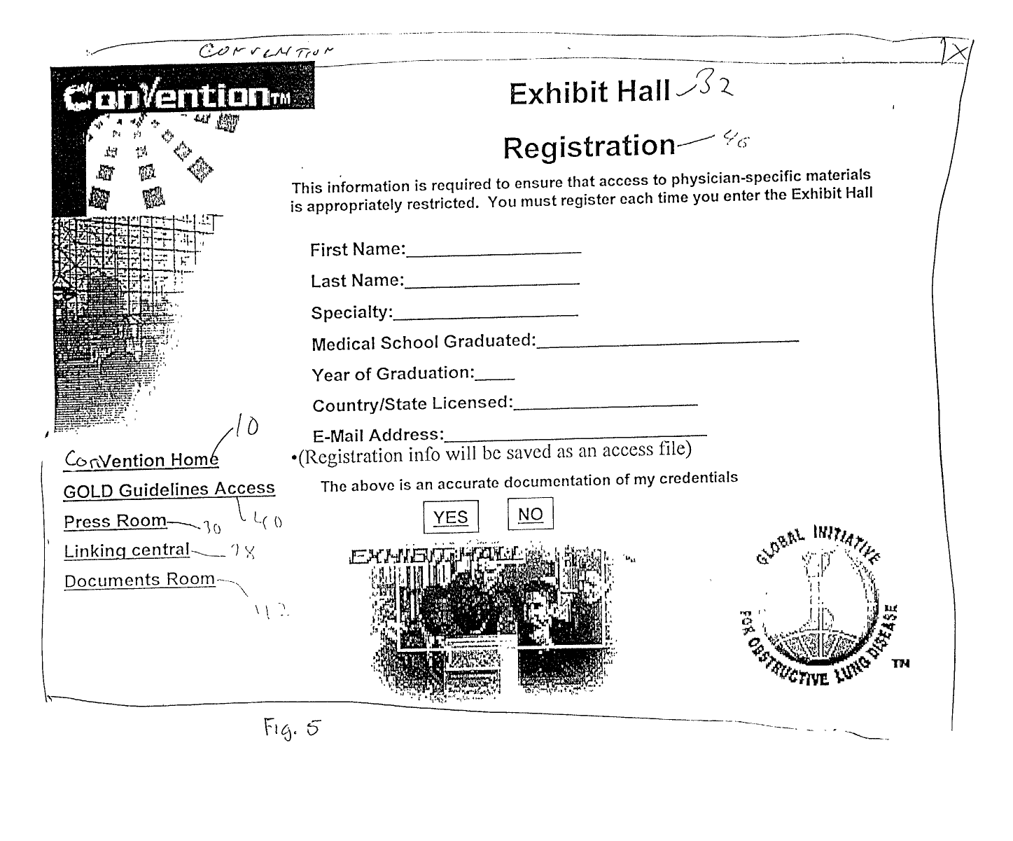

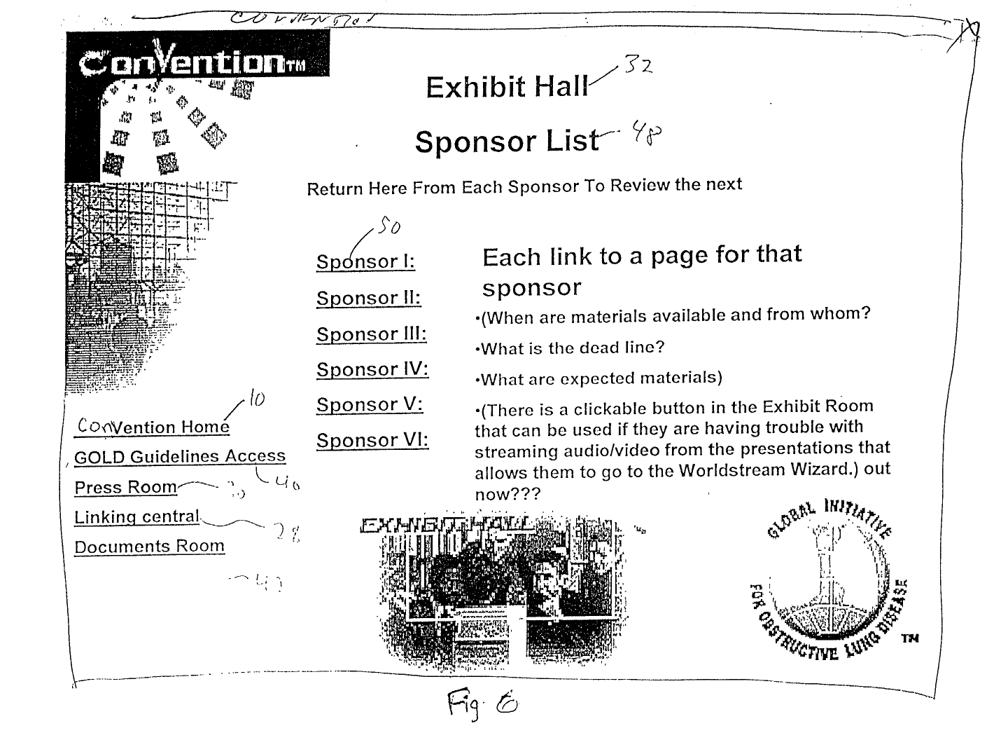

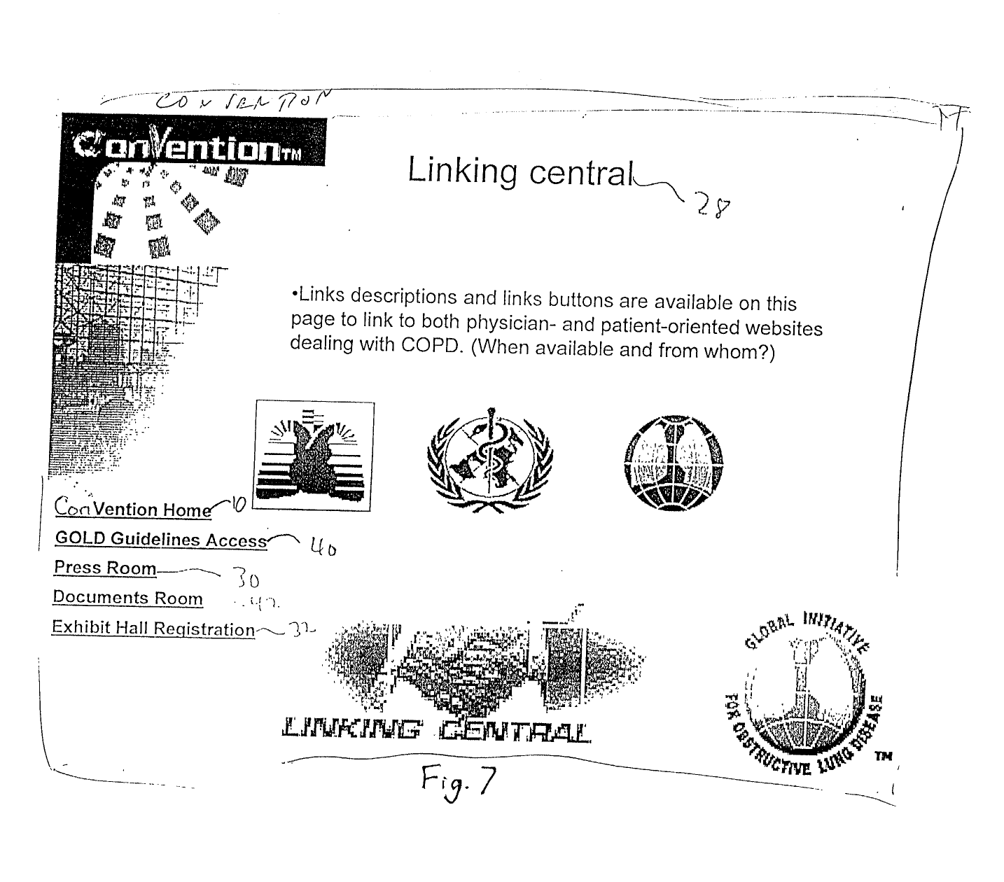

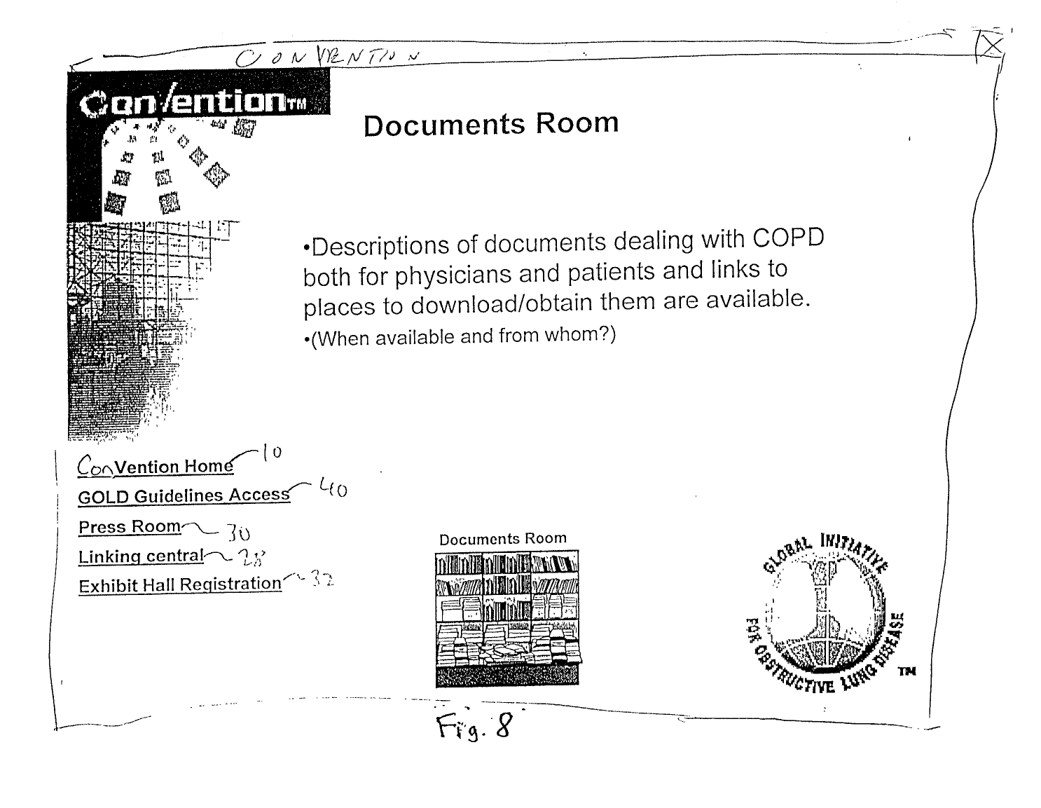

Press Room 30 provides a link to a web page, as illustrated in FIG. 4, having further links to various press releases 44 or press conferences available for review. Preferably, a picture or graphic representing the individual or entity from whom the press release is provided by is next to each link. Also, as illustrated in FIG. 3, links to other pages in the present invention, such as home page 10, linking central 28 and documents room 42, are provided in each page. FIG. 5 illustrates the registration page 46 for the exhibit hall 32. This information is required to ensure that access to physician-specific materials is appropriately restricted. Registration information may be saved that access file for later use. Registration information preferably includes the registrant's name, specialty, medical school attended, year of graduation, country or state licensing data and e-mail address, and the registrant is required to confirm the accuracy of this information by pressing a graphical representation of a button with the cursor. Exhibit hall 32 also comprises a page, as shown in FIG. 6, having sponsor list 48. Sponsors 50 are listed on the page illustrated in FIG. 6 and a link to a page for each sponsor is provided. FIG. 7 illustrates a page for linking central 28 having links to various physician and patient-oriented web sites of interest. FIG. 8 illustrates a web page for documents room 42 having links to documents related to subject matter of interest to both physicians and patient's attending the online convention.

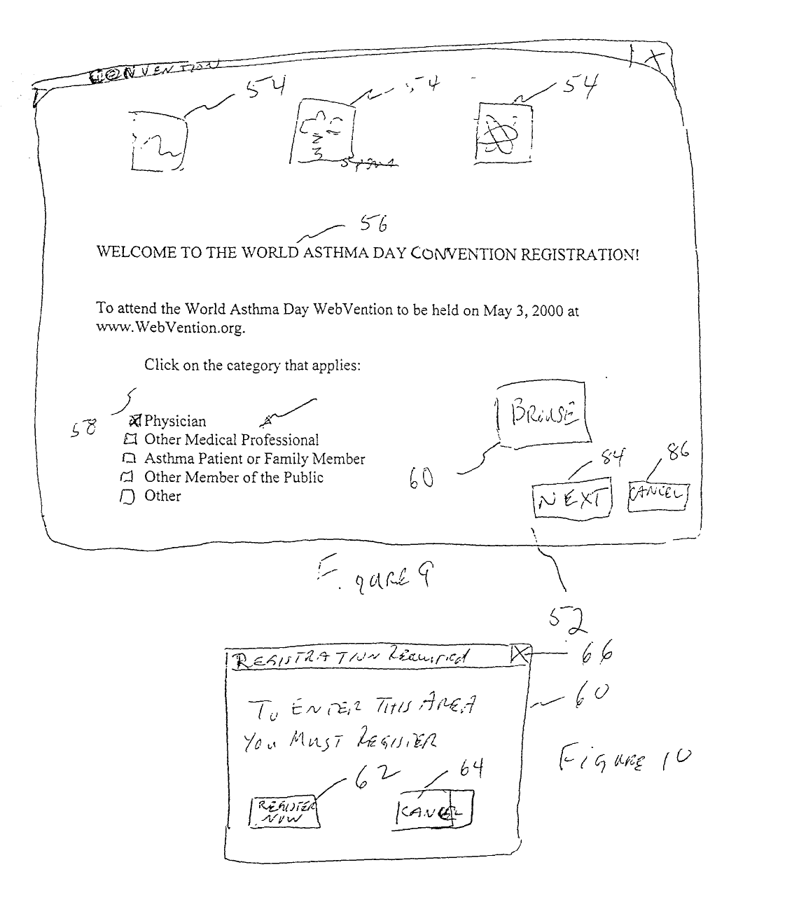

As alluded to above, a person entering the website of the electronic convention is presented with a convention center homepage 52, such as that illustrated in FIG. 9. Homepage 52 includes a plurality of logos 54 which may be logos of sponsoring organizations or other entities which the operators of the convention wish to promote. Also included is a welcome statement 56 and a solicitation 58 inviting the participant to identify himself to the system by formally complying with the requirements for registration and becoming a registered participant at the website convention. In the event that the individual does not wish to comply with the invitation of solicitation 58, the user is permitted to browse the system by clicking on button 60, although such browsing will be limited.

When the person browsing the website clicks on button 60, the user is presented with the convention homepage 10 illustrated in FIG. 2. At any point, by clicking on button 14, the person browsing the site may become a registered participant at the convention providing information about himself and pay the required fee, for example by credit card.

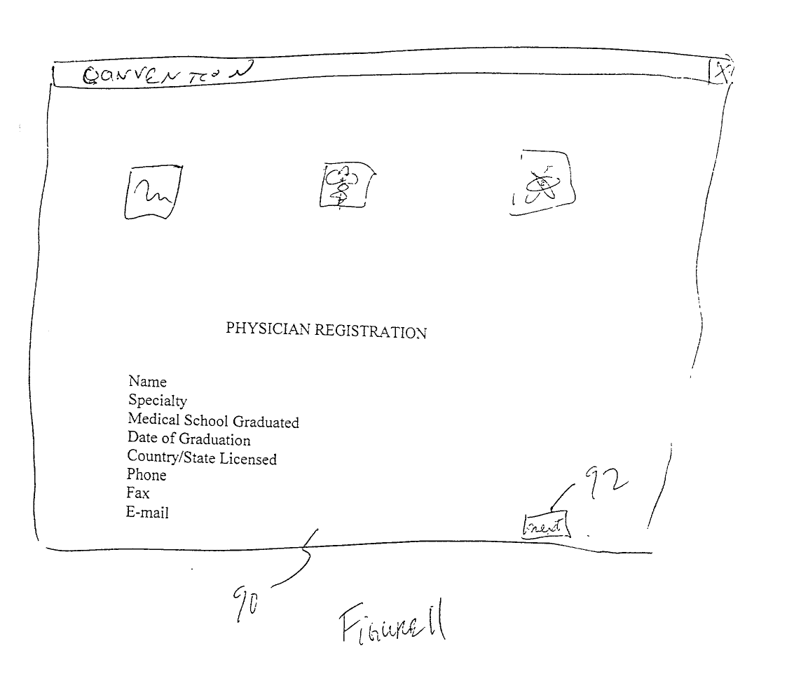

In the event that the person browsing the website goes into an area where registration is required, the system produces a notice 60, such as that illustrated in FIG. 10, requiring the browser to register. Notice 60 is superimposed on the particular screen which the user is viewing. If the user wishes to register the user may click on button 62. Alternatively, the user may choose to continue browsing by clicking on button 64 and exiting or the user may choose to exit by clicking on exit symbol 66.

The operation of the system in this regard is illustrated in FIG. 1. In particular, when the user enters homepage 52 at step 68, the system determines at decision step 70 whether the user is a registered convention participant. If the user is registered, the user is invited to enter his password at step 72 and then passed on to the convention without restriction for his particular class of registration at step 74.

If the user is not registered, the system proceeds to step 76 where limited browsing of the convention is permitted. The system allows browsing until a sensitive part of the site is activated, at which point the system moves to step 78 where notice 60 in FIG. 10 is presented. If the participant elects to register, as noted above, the user is invited to provide information and a payment to enter the convention at step 80. The user is then provided with convention software at step 82 and redirected to the homepage of the convention at step 68.

In the event that a user browsing the website decides that the user does not want to register at step 78, the user is returned to the limited access browsing allowed by the system at step 76.

As noted above, when the individual decides to register the user is presented with the registration screen illustrated in FIG. 9. The user then clicks on “'” button 84 or opts out to unregistered use by clicking on the “cancel”0 button 86, after indicating the appropriate category by checking the appropriate box in query section 88.

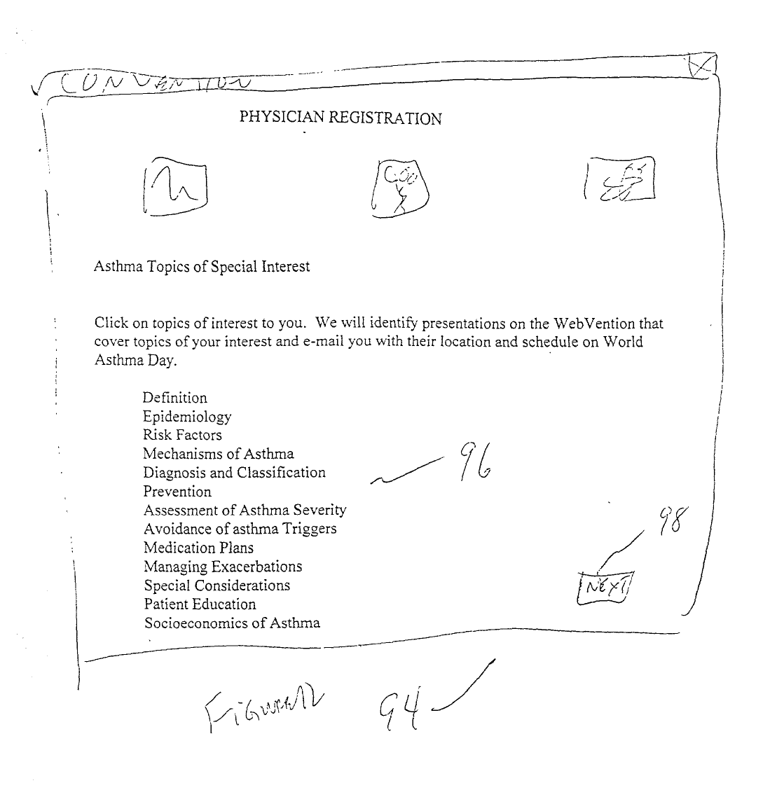

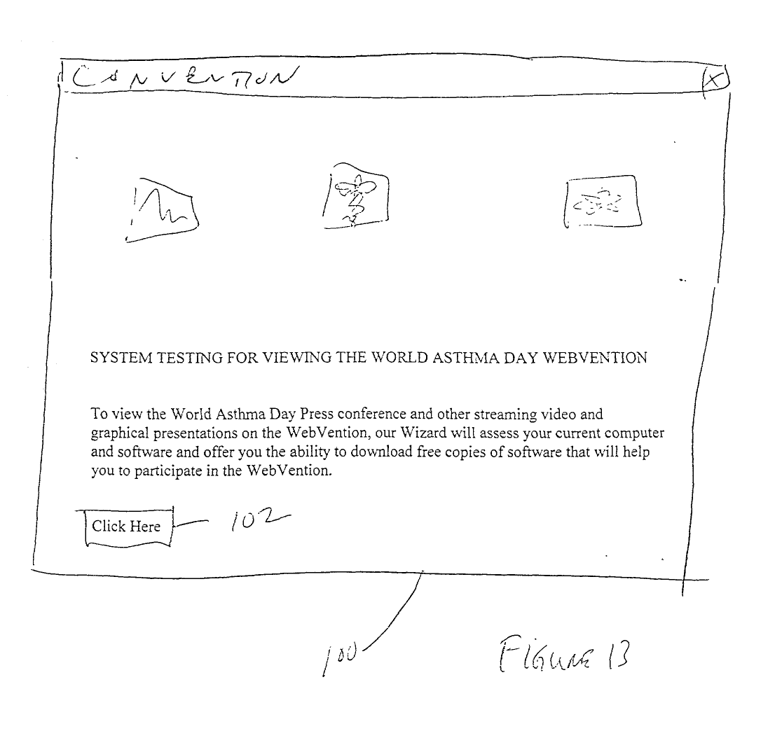

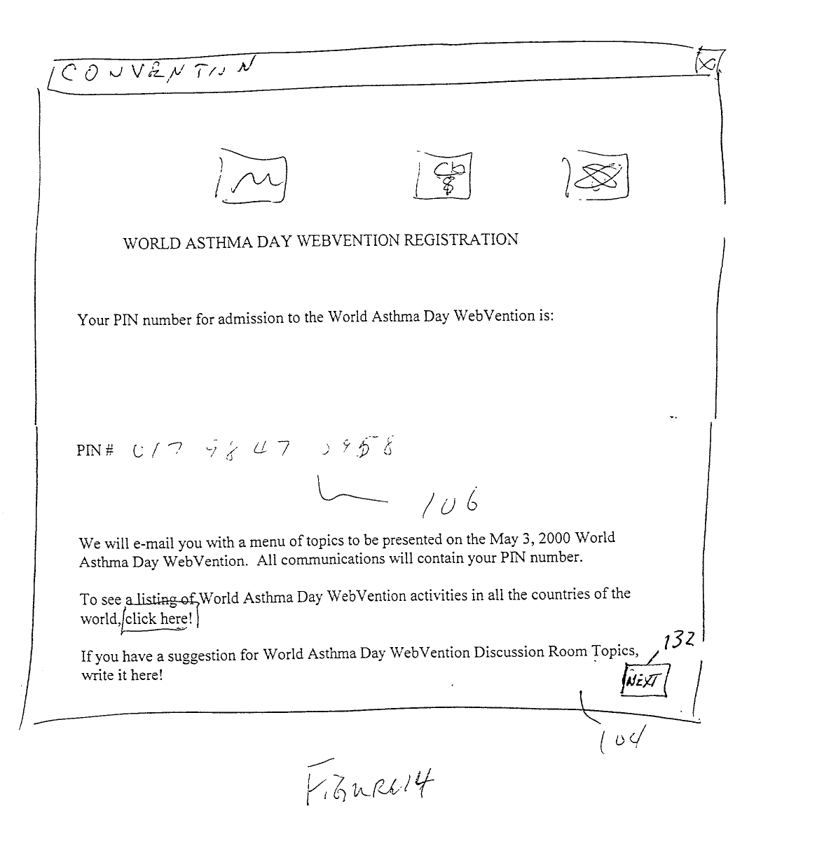

After the participant has indicated the appropriate category in FIG. 9, the user is sent from the FIG. 9 screen to the appropriate screen. For example, if the person visiting the website is a physician, he would check the box indicating the same, as illustrated in FIG. 9, by clicking on it, and would then be presented with the first registration screen 90 for physicians, as illustrated in FIG. 11. As noted above, the information requested in screen 90 would be filled in by the physician and upon completion, the physician would click “next” button 92, which would result in his being sent to screen 94 in FIG. 12, where the user would be asked to indicate his interests in the area 96. Following completion of this information and physician clicks on button 98 and is sent to screen 100 in FIG. 13. Here the physician is given the opportunity to receive the software required for full use of the website by clicking on button 102.

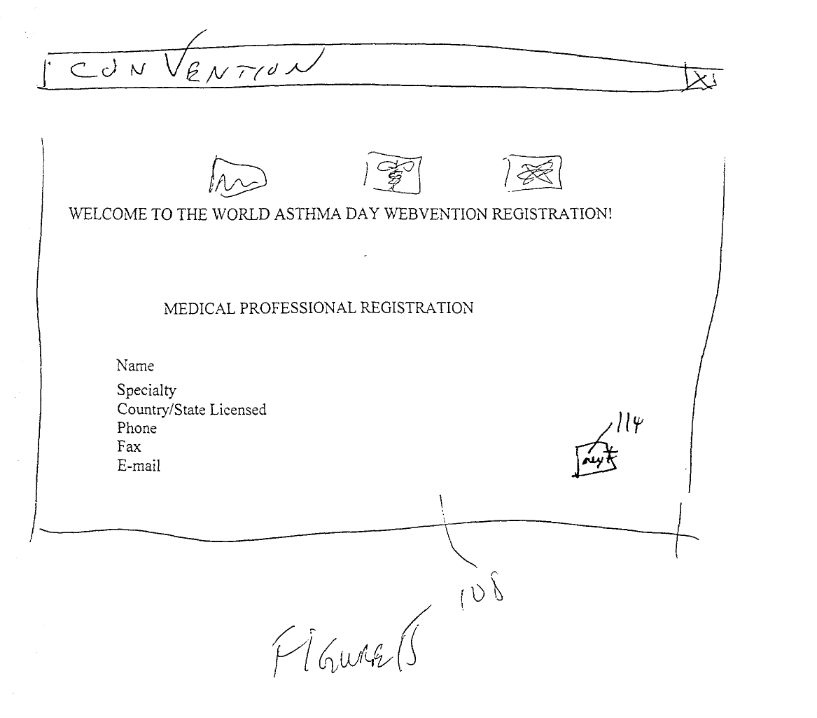

The system then proceeds to present screen 104 illustrated in FIG. 14 where a PIN number (personal identification number) is communicated to the physician user in area 106. In addition, other useful information is communicated to the physician in the remaining portions of screen 104.

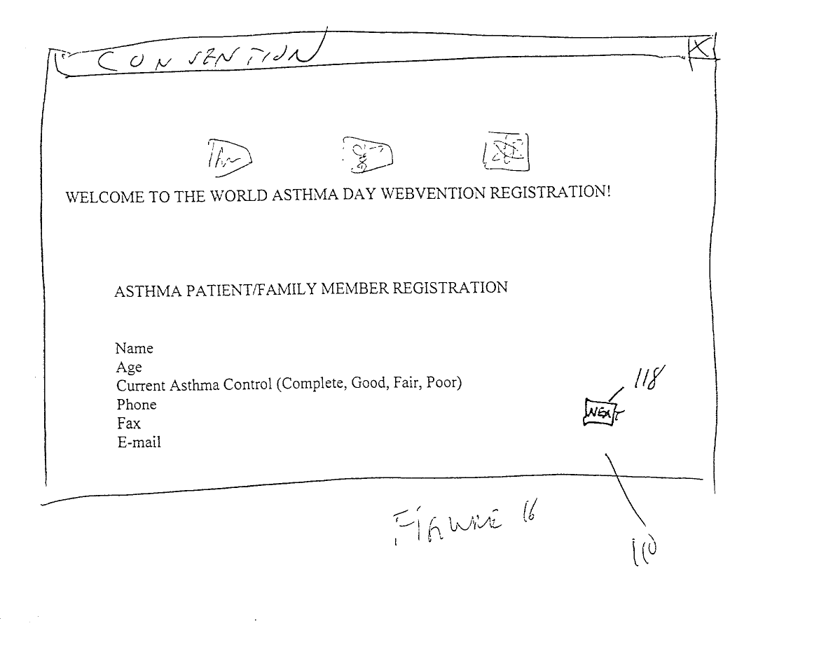

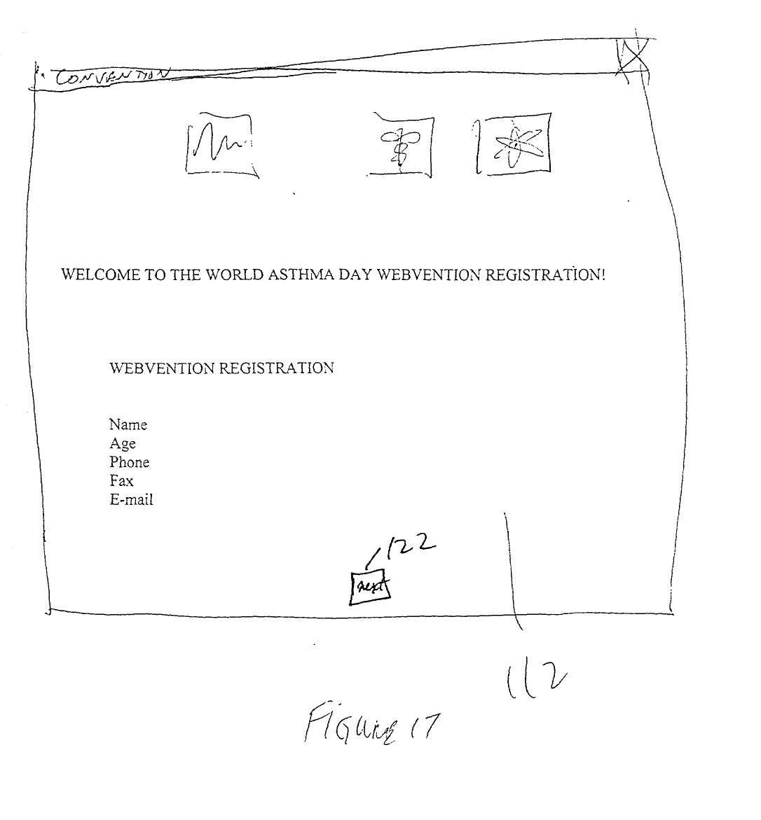

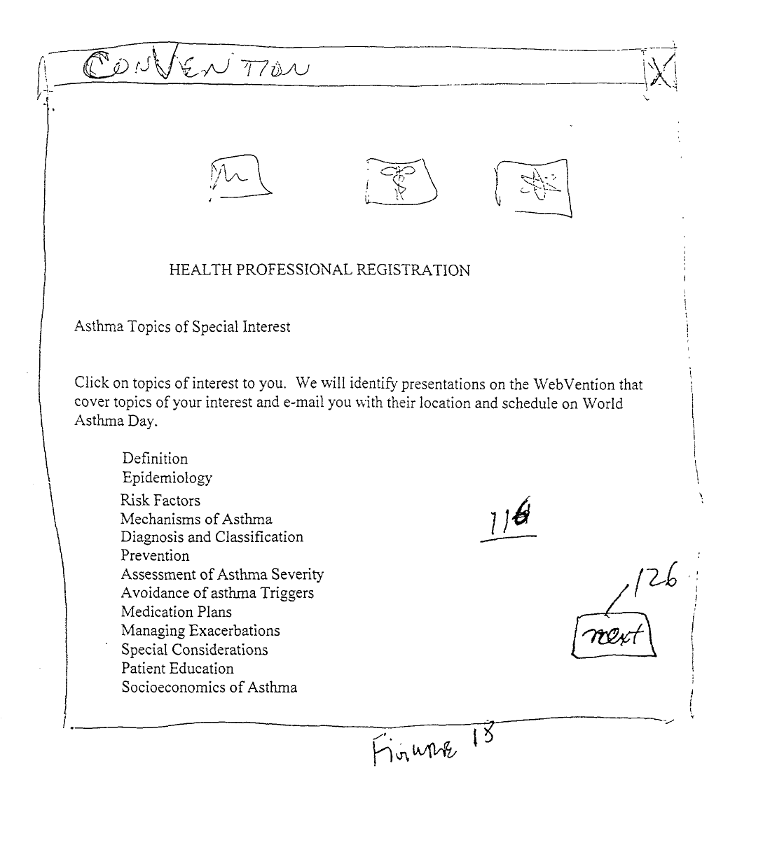

An alternative screen 108 similar to screen 90 in FIG. 11 is illustrated in FIG. 15. However this screen, instead of being devoted to use by a physician, is, instead, used by other medical professionals who have checked the appropriate box in screen 52, illustrated in FIG. 9. A similar screen 110 for patients and their families is illustrated in FIG. 16. Likewise, another screen 112, useful for members of public is illustrated in FIG. 17 and is presented to those individuals who indicate that they are members of public in response to the query in screen 52 in FIG. 9. Likewise, the screen of FIG. 17 may be presented to those individuals who select “other” in response to the query of screen 52, as well as those who select “other member of the public” in response to the query of screen 52.

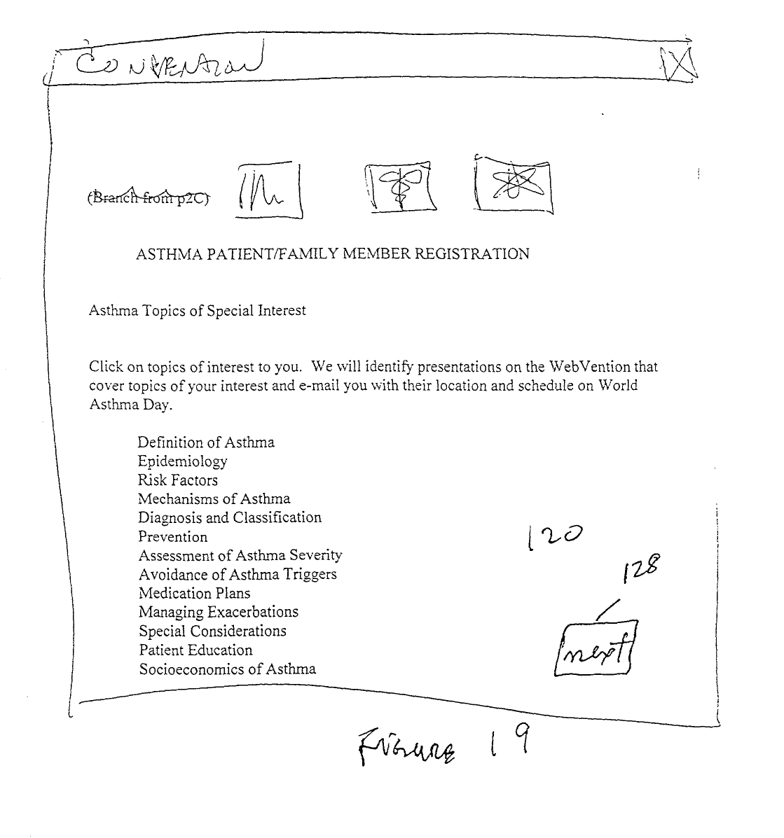

Turning to FIG. 18, after clicking on “next” button 114 on screen 108 in FIG. 15, other health professionals are provided with a second registration screen 116 within which to indicate their areas of special interest. Screen 116 is analogous to screen 94 in FIG. 12, and has conceptually and/or substantially identical content and functionality.

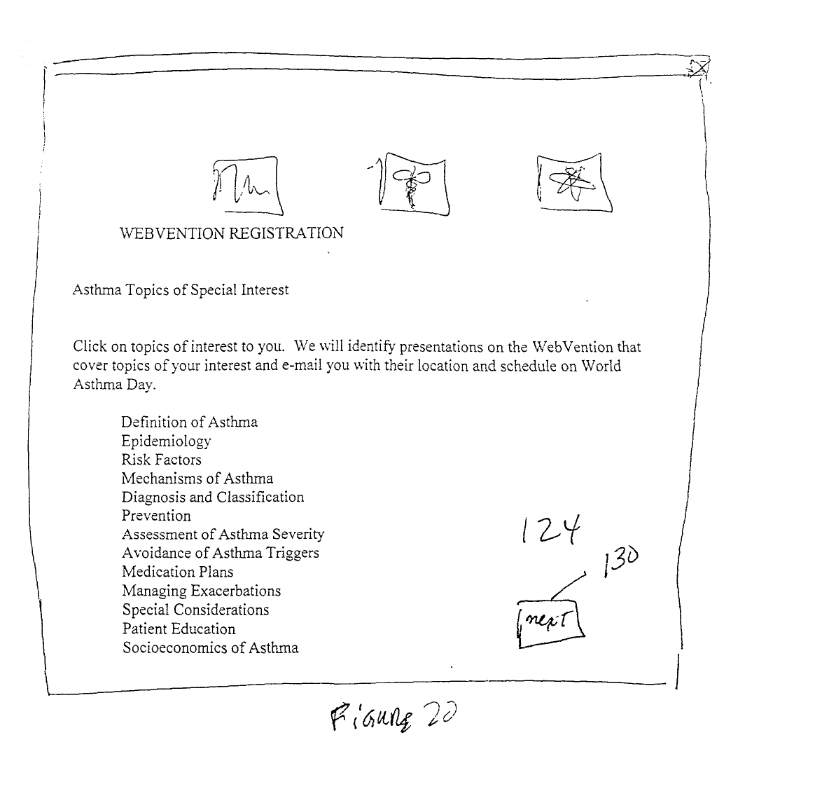

Likewise, turning to FIG. 19, after clicking on “next” button 118 on screen 110 in FIG. 16, patients and family members are provided with a second registration screen 120 within which to indicate their areas of special interest. Screen 120 is analogous to screen 94 in FIG. 12, and has conceptually and/or substantially identical content and functionality.

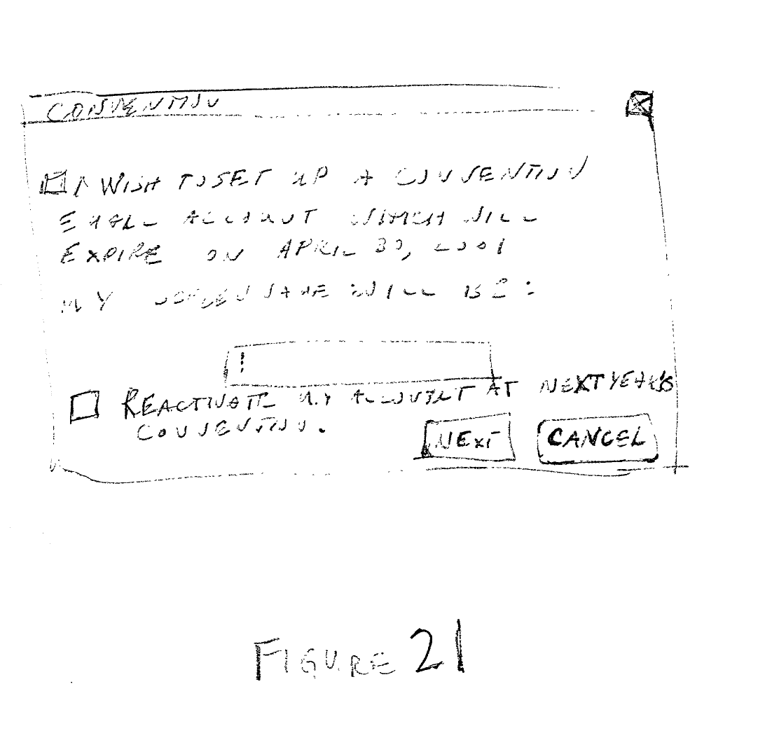

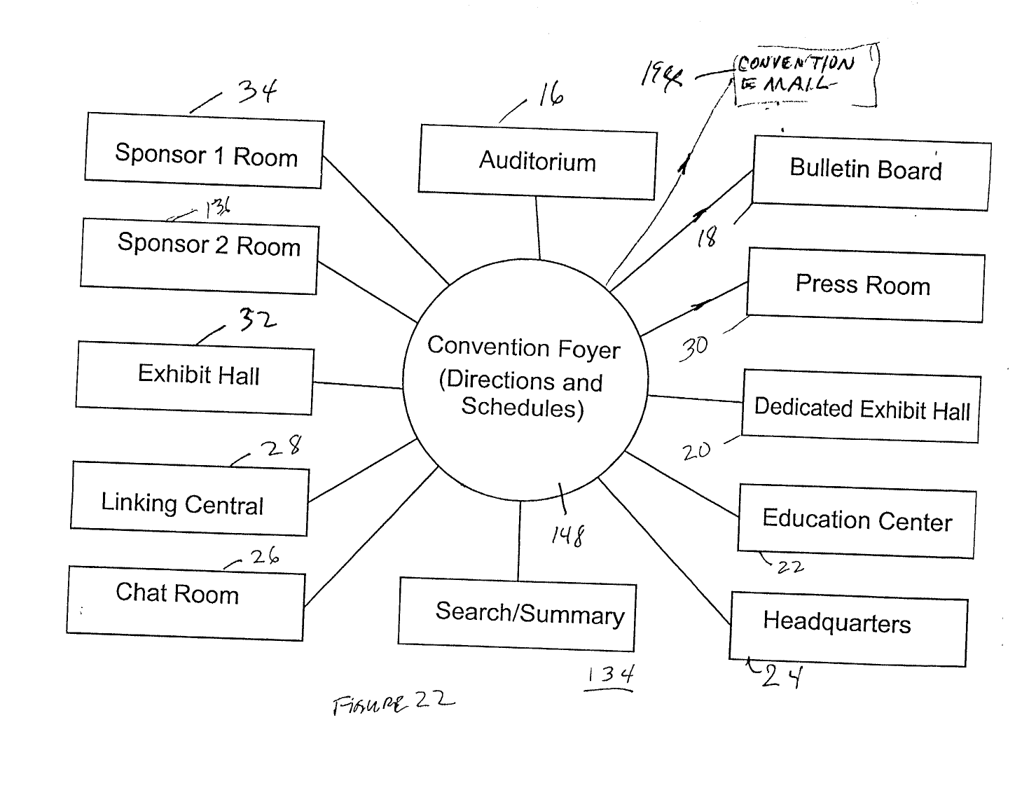

Similarly, turning to FIG. 20, after clicking on “next” button 122 on screen 112 in FIG. 17 members of the public wishing to register are provided with a second registration screen 124 within which to indicate their areas of special interest. Screen 124 is analogous to screen 94 in FIG. 12, and has conceptually and/or substantially identical content and functionality.

At this point, the various branches for medical doctors, other health professionals, patients and family members, and other members of the public merge. It is also contemplated that the user, at this point may be presented with the option of a convention email account with a known limited period of existence. This is meant to encourage users to provide a means for them to be contacted, but without fear of being “spammed” with unwanted email and/ or having their privacy compromised. This may be done by way of screen 125 in FIG. 20, the contents of which reflect the above information. Screen 125 has a space for the entry of a screen name by the user, as well as a notice that the e-mail account will expire on an indicated date. In accordance with the preferred embodiment, the user is also given the option of reactivating his e-mail account at a later convention and a box provided to allow this option to be selected. Alternatively, users can be asked for their regular permanent email addresses.

In accordance with the invention, when an other health professional user of the website clicks on button 126 in FIG. 18, he is sent to screen 100 in FIG. 13. In the case of an asthma patient or family member user, the user is also sent to screen 100 in FIG. 13 when the user clicks on button 128 in FIG. 19. Finally, in the case of a member of the public user, the user is also sent to screen 100 in FIG. 13 when the user clicks on button 130 in FIG. 20.

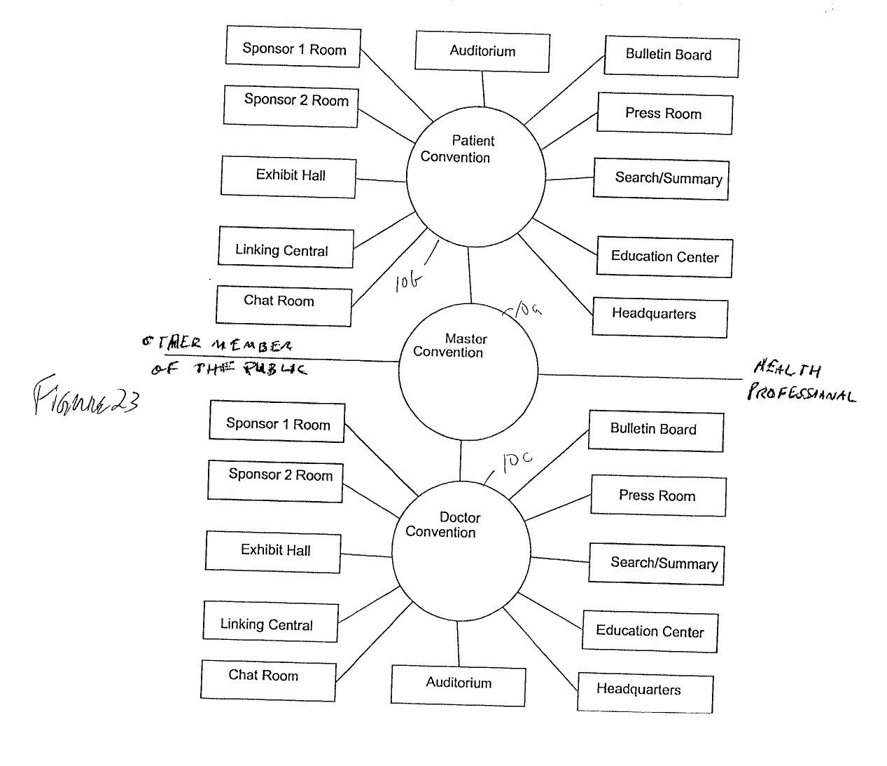

After clicking on button 102 in screen 100 as illustrated in FIG. 13, the various users are sent to screen 104 in FIG. 14, where they are given personal identification numbers. They then click on button 132 which results in the presentation of a wheel of events screen 134, for example, as alternatively illustrated in FIG. 22. Screen 134 may take the physical form illustrated in FIG. 2 with elaborate graphics, and the like or it may be as simple as the alternative screen illustrated in FIG. 22, which has been numbered identically for elements with corresponding functions.

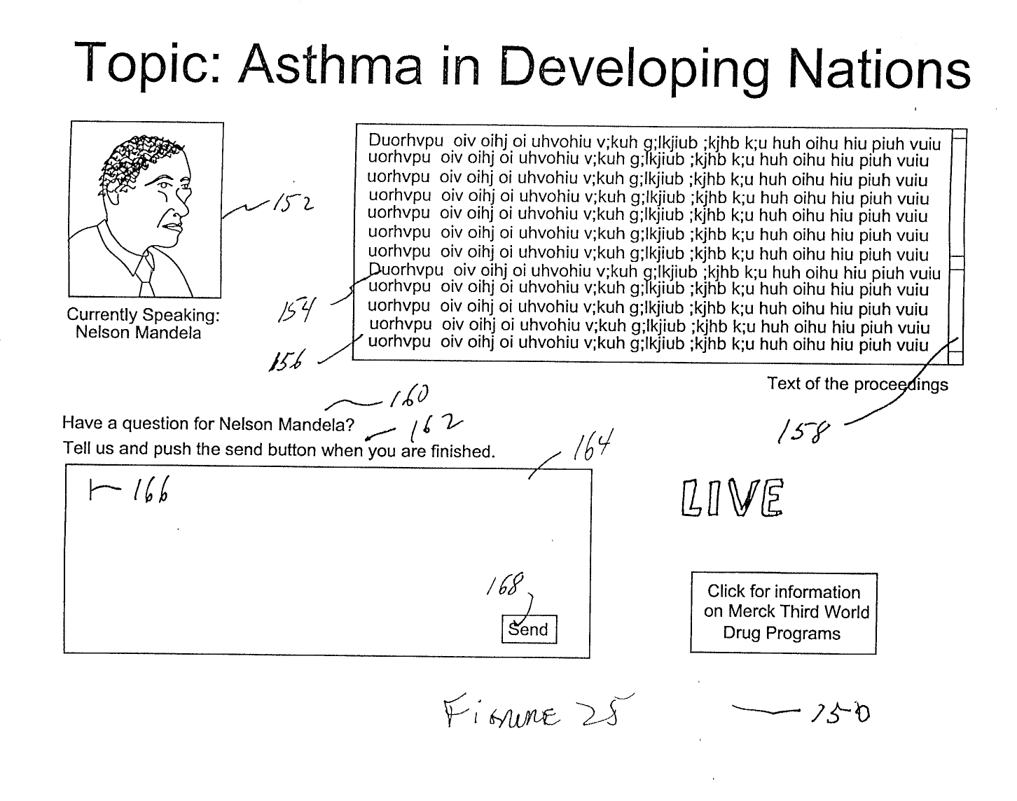

In addition, multiple examples of different branches may be included. For example, as illustrated in FIG. 22, an additional sponsor room 136 may be provided. Likewise, exhibit halls may be general including the exhibits of many companies, or they may be dedicated to a particular company as in the case of exhibit hall 20. In accordance with the invention, it is contemplated that dedicated exhibit hall 20 may be a link to the website of a sponsor or other company. This has the desirable result of reducing traffic on the website of the convention operator. For example, clicking on button 20 may have the result of sending the user to the website of an organization such as the homepage 138 illustrated in FIG. 24. Such a homepage would be designed to include a “Go Back to the Convention” button 140 which would take the user back to the wheel of events screen.

In accordance with another alternative embodiment of the invention, it is contemplated that a wheel of events screen, such is that illustrated in FIG. 2 could optionally include identification of another convention with a suitable indicator 142. Clicking on indicator 142 to select the alternative convention (or indicator 144 which indicates the first convention) would cause that indicator to be highlighted as illustrated at 146 in FIG. 2. In such a case the various events, areas and the like indicated in FIG. 2 would be specific to the highlighted convention.

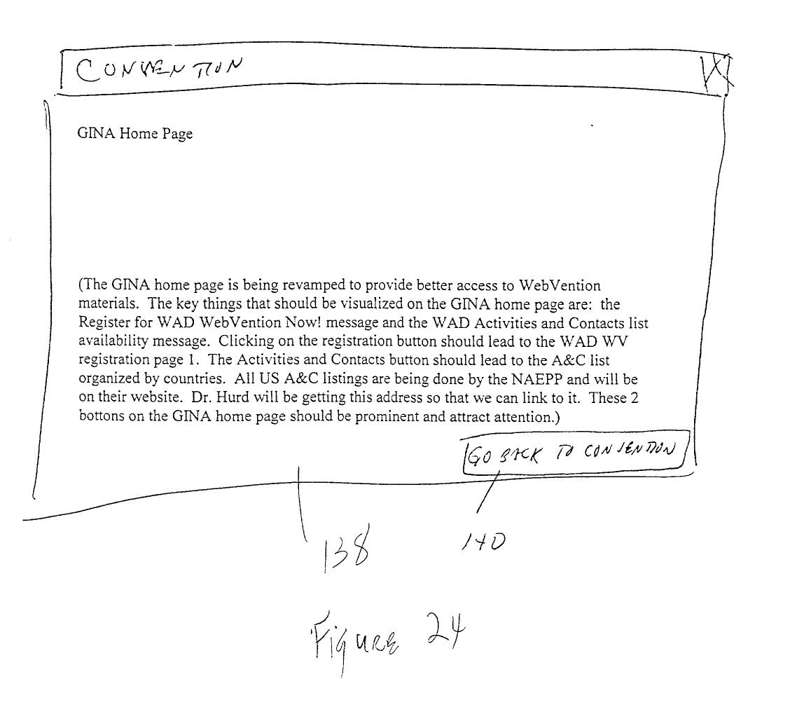

In such a case, the display in FIG. 2 can be viewed as a generic display of two different wheels of events and clicking on one convention or the other would cause the wheel to take the same or similar appearance but have different functionality. This diversity of functionality is illustrated in FIG. 23 where a master convention homepage 10a is replaced by specific convention homepages 10b or 10c, depending upon the convention selection made by the user. Each specific convention homepage 10b and 10c has its own set of pages to which it links. In the event that the visitor to the website has not selected a convention, he may be prompted, after clicking on an icon in the wheel to select one convention or the other, if there is more than one convention being hosted by the website.

Referring to FIG. 22, the operation of the inventive system may be understood in detail. In particular, when a user clicks on the button 148 he is brought to a screen page which has general information about the convention, including, directions on how to use the website and schedules of various live events. The user may then simply click the “back” button on his Internet browser to return to the screen of FIG. 22, as he can with pages brought up by any of the buttons illustrated in screen 134 in FIG. 22.

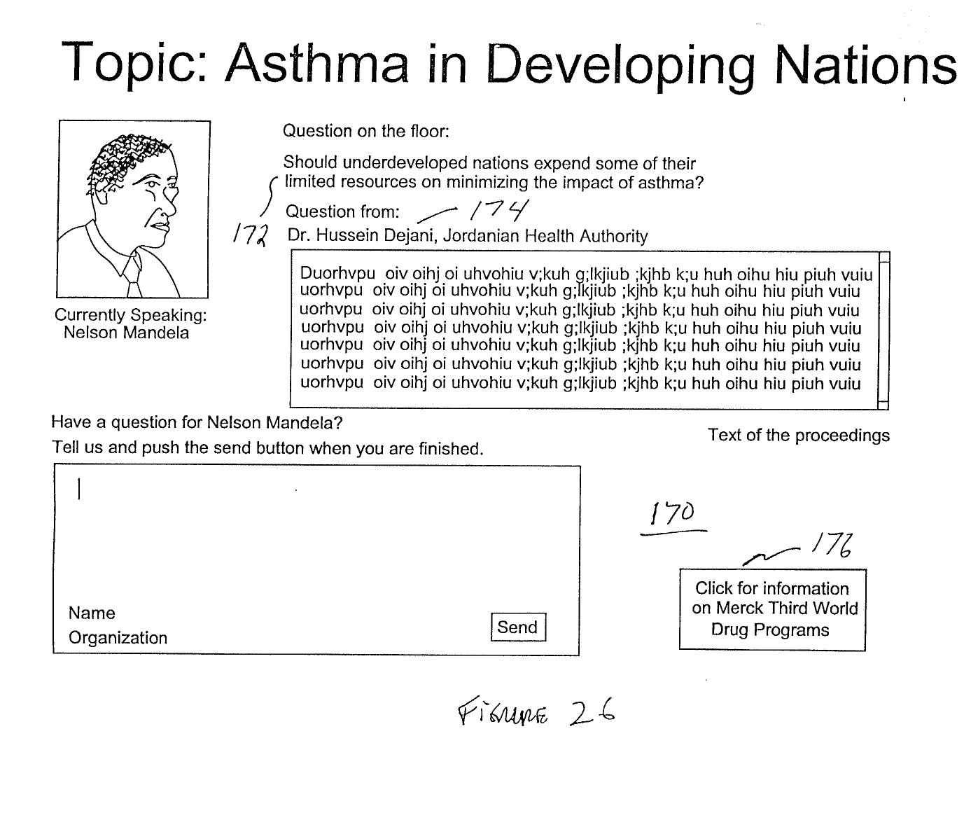

When the user clicks on button 16, he is brought to the event which is going on in the auditorium. For example, in accordance with the invention, the event may be an address by Nelson Mandela respecting asthma in developing nations. The event may be received in audio form accompanying a screen 150, as illustrated in FIG. 25. Screen 150 may include a picture 152 (or a series of pictures) of the speaker, as well as a complete text of the address 154 in a window 156. The window is provided with a scrolling feature indicated by icon 158. In addition, participants in the conference may be asked by text 160 whether they wish to question the speaker and invited and instructed to send such a question by text 162. It is contemplated that a window 164 for receiving such text can be provided by typing at cursor 166.

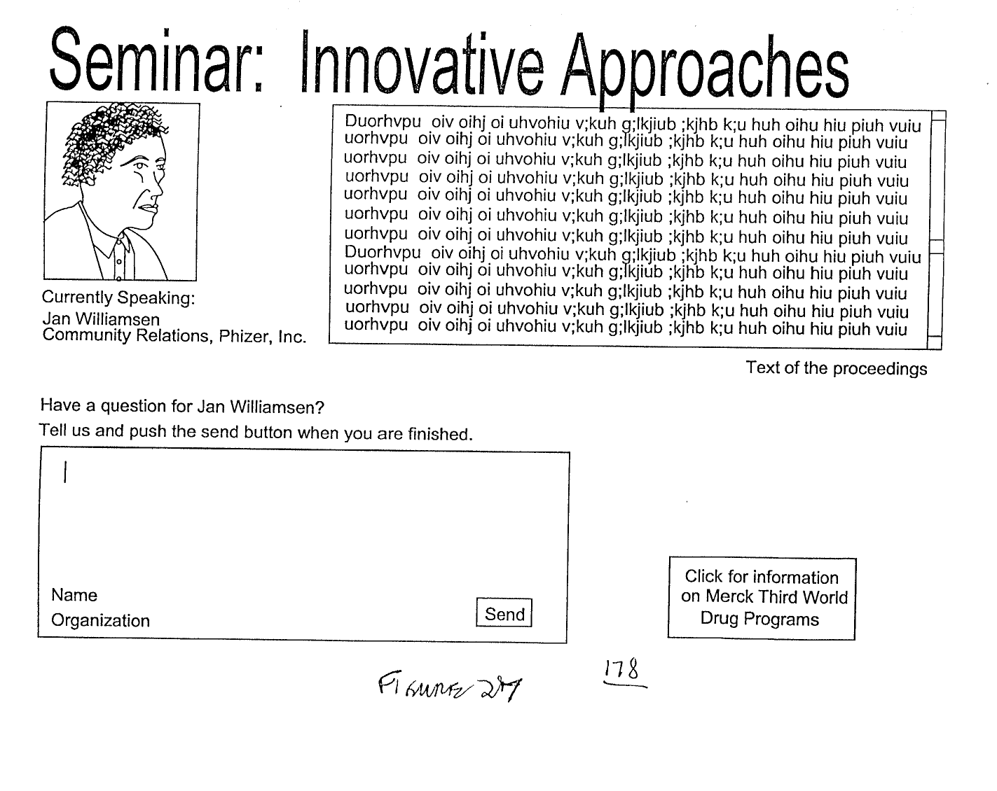

When a question is completed the user simply clicks on a “send” button 168, to send a question to the speaker who can then answer the question, if it is selected to be answered. The display of screen 150 would then change to screen 170, as illustrated in FIG. 26. In particular, the question is indicated by text 172. In addition, the source of the question may be indicated by text 174. In addition, an advertisement for related information may be accessible by a button 176, which may take the form of a hyperlink to another website, which in accordance with the present invention reduces traffic on the website of the convention organizer, as well as provides flexibility for the sponsor or other person who is at the other end of the hyperlink to control the content of the screen to which the hyperlink points.

In accordance with the invention is contemplated that the talk given by Mr. Mandela would be available at later times in order to accommodate users in different time zones. Likewise, in accordance with the present invention, the talk would be available in multiple languages.

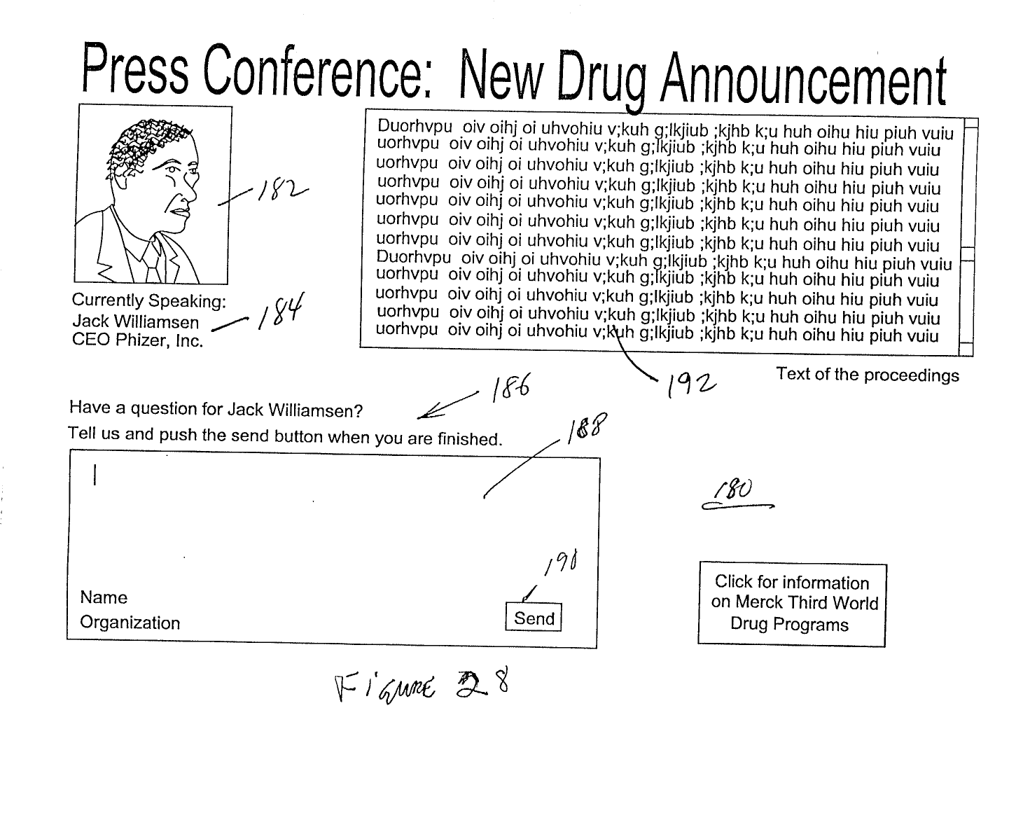

As noted above, the system also includes an education center which may be accessed by clicking on button 22. Here again, in accordance with the present invention, button 22 may be a hyperlink to another website which absorbs traffic and includes suitable buttons for sending the traffic back to the main convention. More particularly, by clicking on education center button 22, a user could bring up a screen 178 as illustrated in FIG. 27. Screen 178 may be similar to the screens illustrated FIG. 26 and 27 and contain substantially the same functionality but would, instead, have a higher question-and-answer content to facilitate the educational function of screen 178.

While participation in the live seminar may accessible by screen 178 in FIG. 27, in accordance of the invention, the proceedings, including the various questions, answers and comments of the persons participating in the seminar reflected by screen 178 are made available throughout the duration of the convention, in order to accommodate users in different time zones.

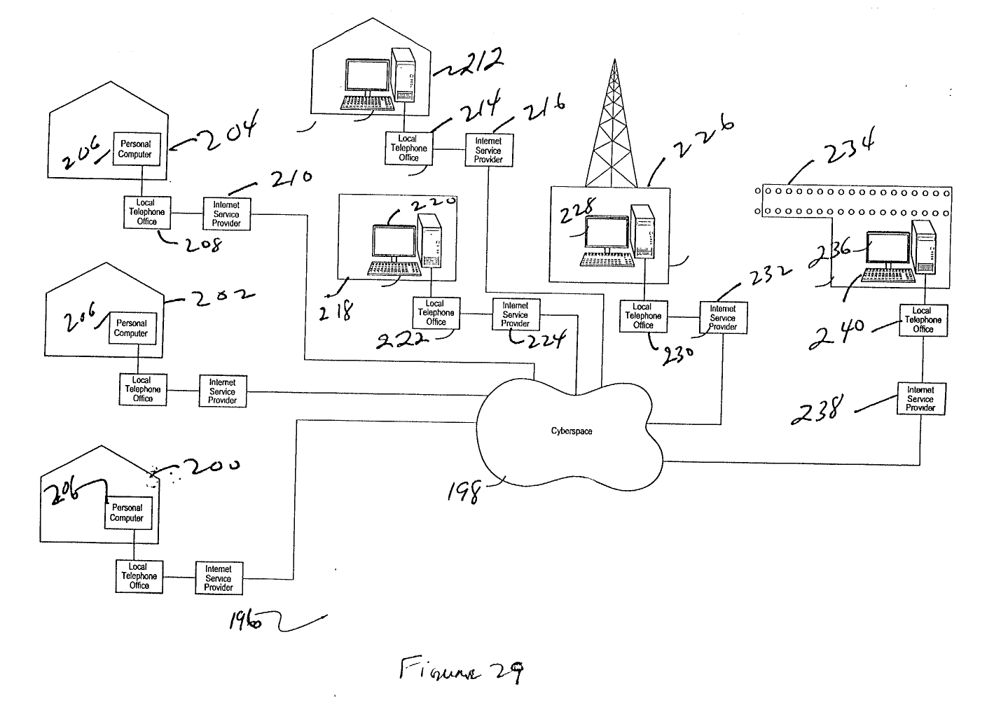

As noted above, the wheel of events exemplified by screen 134 in FIG. 22 also includes a button 30 meant for providing access to a pressroom. This would be the place where various press conferences would be held, again, as in the case of the seminar and auditorium events, accompanied by an audio transmission which can be heard at the computer of a person using the website to attend a convention. Users may access to the pressroom by clicking on button 30, which brings them to screen 180 in FIG. 28. In particular, screen 180 is provided to provide accessibility of the press conference to order a convention user. Screen 180 includes a picture 182 of the speaker, text 184 identifying the speaker, text 186 inviting questions and a window 188 for receiving the questions which can be sent by clicking on send button 190. The text of the press conference including the initial address and questions and answers is provided live in box 192 and may be accessible throughout the duration of the convention.

If desired the text of the statement which precedes the question-and-answer period at the press conference may be accessible both before and after the press conference is held.

It is noted that in accordance with the present invention, the various talks, seminars and press conferences are made available on a 24-hour basis with scheduling accommodating the convenience and body clocks of the various participants in the convention.

By clicking on bulletin board 18, the user will be brought to a page giving a listing of attendees, as well as a button for receiving personal messages sent to the user by other participants to the convention. In this respect it will connect with the e-mail function of the website which can also be accessed by clicking on button 194 in FIG. 22. In addition, the screen page associated with bulletin board 18 will also include messages of general interest from the management of the convention and a button for clicking on to a screen which includes all general messages from any participants at the convention. Such general messages may be provided selected areas according to topic.

By clicking on button 24, the participant is brought to a page with general information, frequently asked questions, and the like, as well as functionality for receiving questions from participants at the convention to be answered by those persons running the convention.

Clicking on button 26 may bring the participant directly into a chat room, or, in accordance with a preferred embodiment, will bring up a menu of chat rooms on different topics any one of which may be clicked on and thus made available to the participant to the conference.

By clicking on button 28, the participant is brought to a page listing all hyperlinks associate with the convention, organized by subject matter or any other suitable way, such as alphabetically according to author.

Sponsor rooms 34 and 136 may take any one of a number of forms to be controlled by the sponsor. Such functionality may include e-mail, product information, research, entertainment and so forth.

Referring to FIG. 29, a system 196 useful for implementing the website of the present invention, which may take the form of the Internet and a number a personal computer users, is illustrated. In particular, all connections are made through the Internet 198. Individual participants 200, 202 and 204 are simple convention attendees that may be located in their homes. Each of the participants has his own personal computer 206 which he uses to access the Internet through his local telephone office 208 and an Internet service provider 210. All participants are connected into cyberspace 198. This would include a person 212 giving a seminar who may likewise be located at home order and office, connected to the convention through a local telephone office 214 and Internet service provider 216 to the Internet.

A company which is sponsoring the convention would operate from its own facility 218 through a personal computer 220 connected by its local telephone office 222 and its Internet service provider 224 to cyberspace 198. The company hosing the convention likewise may operate from its facility 226 using a personal computer 228 and connected via its local telephone office 230 to its Internet service provider 232 and ultimately cyberspace 198. Computer 228 is programmed with software performing the above functions defined above as assigned to the company which is hosing the convention, thus enabling it to register convention participants, collect fees, operate a pressroom, chat rooms, convention headquarters, a bulletin board and educational center, as discussed above. However, one or more of these functions may be advantageously farmed out through hyperlinks to other servers thus reducing the load on computer 228.

Finally, the auditorium may also take the form of an actual auditorium or theater 234 connected to the convention through a personal computer 236, which in turn is connected to its Internet service provider 238 by its local telephone office 240, thus providing a connection to cyberspace 198 and the other participants to the convention.

While some illustrative embodiments of the invention have been described above, it is, of course, understood that various modifications will be apparent to those of ordinary skill in the art. Such modifications are within the spirit and scope of the invention, which is limited and defined only by the appended claims.

1. A method for establishing a conference between two or more users, comprising the steps of:
(a) registering participants in the conference;
(b) providing software to said participants, said software permitting the participant to have a screen name and password security, said software providing a communication device between participants when the participants are connected to a public network such as the world wide web; and,
(c) installing the software on said participants' computers.

2. A method for establishing an electronic convention comprising the steps of:
(a) providing a central server programmed with convention software adapted
(i) to register participants to a convention over a publicly accessible or privately accessible computer network,
(ii) make available over said publicly accessible or privately accessible computer network information of interest to said participants to said convention; and
(iii) receive information from said participants over said publicly accessible or privately accessible computer network; and
(b) providing a plurality of screens to participants from said central server, at least one of said screens including a hyperlink which may be clicked on to transfer traffic to a second server other than said central server, said second server performing at least one convention function.

3. A method as in claim 2, wherein said second server provides a plurality of pages, at least one of which pages on said second server has a button which may be clicked on to return a convention registrant to said central server.

4. A method as in claim 2, wherein said second server provides a plurality of pages, at least half of said pages on said second server having a respective button which may be clicked on to return a convention registrant to said central server.

5. A method for establishing an electronic convention comprising the steps of:
(a) providing a central server programmed with convention software adapted
(i) to register participants to a convention over a publicly accessible or privately accessible computer network,
(ii) make available over said publicly accessible or privately accessible computer network information of interest to said participants to said convention; and
(iii) receive information from said participants over said publicly accessible or privately accessible computer network; and
(b) providing a screen providing the option to convention registrants of a convention email account with a known limited period of existence, said screen informing the registrant respecting the time limited nature of said convention e-mail account.

6. A method for establishing an electronic convention comprising the steps of:
(a) providing a central server programmed with convention software adapted
(i) to register participants to a convention over a publicly accessible or privately accessible computer network,
(ii) make available over said publicly accessible or privately accessible computer network information of interest to said participants to said convention, wherein said information is made available in the form of a plurality of website pages; and
(iii) receive information from said participants over said publicly accessible or privately accessible computer network;
(b) making available to potential registrants to said electronic convention a page receiving identification and money transfer information;
(c) making available to persons which register into said electronic convention all website pages; and
(d) making available to persons who do not register into said electronic convention only a limited number of website pages.

7. A method as in claim 6, further comprising the steps of:
(f) detecting the clicking by a potential registrant on any function meant to present a website page other than one of said limited number of website pages; and
(g) making available to potential registrants, in response to the detection of the clicking on a function meant to present a website page other than one of said limited number of website pages, said page receiving identification and money transfer information.

8. A method as in claim 7, further comprising the steps of:
(h) giving a potential registrant who has been given the option in response to the detection of the clicking on a function meant to present a website page other than one of said limited number of website pages, said page receiving identification and money transfer information, further option of deciding not to register; and
(i) returning said potential registrant to the limited access browsing allowed by the system.

9. A method for establishing an electronic convention comprising the steps of:
(a) providing a central server programmed with convention software adapted
(i) to register participants to a convention over a publicly accessible or privately accessible computer network,
(ii) make available over said publicly accessible or privately accessible computer network information of interest to said participants to said convention; and
(iii) receive information from said participants over said publicly accessible or privately accessible computer network; and
(b) providing a screen to convention participants to provide the functions of a presentation by a speaker, said screens including:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

10. A method for establishing an electronic convention comprising the steps of:
(a) providing a central server programmed with convention software adapted
(i) to register participants to a convention over a publicly accessible or privately accessible computer network,
(ii) make available over said publicly accessible or privately accessible computer network information of interest to said participants to said convention; and
(iii) receive information from said participants over said publicly accessible or privately accessible computer network; and
(b) providing a screen to participants from said central server, said screen serving as a bulletin board and including general messages to participants located in areas organized according to topic.

11. A method as in claim 10, further comprising the step of:
providing a plurality of screens to participants from said central server, at least one of said screens including a hyperlink which may be clicked on to transfer traffic to a second server other than said central server, said second server performing at least one convention function.

12. A method as in claim 11, further comprising the step of:
providing a screen providing the option to convention registrants of a convention email account with a known limited period of existence, said screen informing the registrant respecting the time limited nature of said convention e-mail account.

13. A method as in claim 12, further comprising the steps of:
(a) making available to potential registrants to said electronic convention a page receiving identification and money transfer information;
(b) making available to persons which register into said electronic convention all website pages; and
(c) making available to persons who do not register into said electronic convention only a limited number of website pages.

14. A method as in claim 13, further comprising the step of:
providing a screen to convention participants to provide the functions of a presentation by a speaker, said screens presented:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

15. A method as in claim 11, further comprising the steps of:
(a) making available to potential registrants to said electronic convention a page receiving identification and money transfer information;
(b) making available to persons which register into said electronic convention all website pages; and
(c) making available to persons who do not register into said electronic convention only a limited number of website pages.

16. A method as in claim 15, further comprising the step of:
providing a screen to convention participants to provide the functions of a presentation by a speaker, said screens presented:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

17. A method as in claim 11, further comprising the step of:
providing a screen to convention participants to provide the functions of a presentation by a speaker, said screens presented:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

18. A method as in claim 10, further comprising the step of:
providing a screen providing the option to convention registrants of a convention email account with a known limited period of existence, said screen informing the registrant respecting the time limited nature of said convention e-mail account.

19. A method as in claim 18, further comprising the steps of:
(a) making available to potential registrants to said electronic convention a page receiving identification and money transfer information;
(b) making available to persons which register into said electronic convention all website pages; and
(c) making available to persons who do not register into said electronic convention only a limited number of website pages.

20. A method as in claim 19, further comprising the step of:
providing a screen to convention participants to provide the functions of a presentation by a speaker, said screens presented:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

21. A method as in claim 18, further comprising the step of:
providing a screen to convention participants to provide the functions of a presentation by a speaker, said screens presented:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

22. A method as in claim 10, further comprising the steps of:
(a) making available to potential registrants to said electronic convention a page receiving identification and money transfer information;
(b) making available to persons which register into said electronic convention all website pages; and
(c) making available to persons who do not register into said electronic convention only a limited number of website pages.

23. A method as in claim 22, further comprising the step of:
providing a screen to convention participants to provide the functions of a presentation by a speaker, said screens presented:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

24. A method as in claim 10, further comprising the step of:
providing a screen to convention participants to provide the functions of a presentation by a speaker, said screens presented:
(i) a picture of the speaker,
(ii) a window with a scrolling feature incorporating the text of the speech of the speaker, and
(iii) an invitation to submit a question to the speaker,
(iv) a field for receiving said question, and
(v) a button for sending said question to set speaker to be included with any response within said window with a scrolling feature.

25. A method for a plurality of electronic conventions, comprising the steps of:
(a) providing through a publicly accessible computer network a website with a conventions homepage including a list of a plurality of conventions being hosted;
(b) highlighting a convention listed in said list in response to its being clicked on by a potential convention registrant;
(c) providing a central server programmed with convention software adapted
(i) to register participants to be highlighted convention over a publicly accessible or privately accessible computer network,
(ii) make available over said publicly accessible or privately accessible computer network information of interest to said participants to said said highlighted convention; and
(iii) receive information from said participants over said publicly accessible or privately accessible computer network; and
(b) providing a plurality of screens associated with said highlighted convention to participants.

26. A method as in claim 25, wherein said plurality of screens associated with said highlighted convention are provided by said central server.

27. A method as in claim 25, wherein, in the event that a visitor to said website has not selected a convention, he may be prompted, after clicking on an icon to select one convention or the other.
